(19) United States
(12) Patent Application Publication
(10) Pub. No.: US 2012/0082784 A1
(43) Pub. Date: Apr. 5, 2012

(54) HOT-MELT EXTRUDED ADHESIVE TAPE

(75) Inventor: Chih-Ming OU, Shengang Township (TW)

(73) Assignee: SUN-GOOD GLUE COMPANY, Ltd., Shengang Dist. (TW)

(21) Appl. No.: 13/316,931

(22) Filed: Dec. 12, 2011

Related U.S. Application Data
(63) Continuation-in-part of application No. 12/421,843, filed on Apr. 10, 2009.

(51) Int. Cl. B05D 5/10

(52) U.S. Cl. 427/208.2

(57) ABSTRACT

A molding method of hot-melt extruded adhesive tape includes a banded or foliated carrier with peelable surface. A feed mechanism is used to feed the carrier by a conveying mechanism. The thermoplastic rubber can be extruded by the extrusion feed mechanism onto the carrier's peelable surface through 0.2 mm˜1.0 mm extrusion port, so that at least a thin-profile and flat extruded adhesive is formed on the peelable surface. An intermittent controller enables the thermoplastic rubber to be arranged onto the carrier's peelable surface at interval or in continuously-extended pattern. A hardening mechanism is used to speed up the hardening of extruded adhesives into solid adhesive. The method can improve substantially the fabrication efficiency of the hot-melt extruded adhesive tapes, thus saving the material cost and improving the adhesion strength with better advantages and applicability.

### CROSS-REFERENCE TO RELATED U.S. APPLICATIONS

The present application is a continuation-in-part of U.S. patent application Ser. No. 12/421,843 , filed on Apr. 10, 2009, and entitled “Hot-Melt Extruded Adhesive Tape”, presently pending.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to a hot-melt extruded adhesive tape, and more particularly to an innovative one which is fabricated by a specific molding method.

2. Description of Related Art Including Information Disclosed Under 37 CFR 1.97 and 37 CFR 1.98.

In the modern society, there are a great number of handicraft workers based on individual interests and job requirements, or owing to wholesale or retail reasons. Such handicrafts include: decorative scrapbooks, splicing paper products, paper sculpture and sewing products, etc. In addition to some ready materials, adhesive is an indispensable element during the fabrication of the handicrafts. Hot-melt glue, liquid glue or spraying glue was previously used as an adhesive. However, hot-melt glue is not suitable for the users, especially for the young or elderly ones, due to certain hazards exposed to higher temperature. Moreover, hot-melt glue will possibly lead to the damage and deformation of some heat-intolerable materials. The liquid glue makes it easy to stain users' hands or overflow to the unnecessary positions, thus affecting the appearance of finished products. As the spraying glue makes it difficult to control accurately the spraying area and quantity, it is only suitable for large-area adhesion in a very limited scope of application.

Additionally, a thermoplastic (or pressure-sensitive) adhesive is another option that is widely applied in the processing of handicrafts. Such thermoplastic adhesive is made available to the users in the foliated or rolled pattern, on which thermoplastic adhesive units are arranged at interval for peeling-off by the users. So, there is a growing trend that this kind of thermoplastic adhesive will replace conventional one due to its ease-of-operation, strong security, water-resistance, repeatability and shock-proofing.

The well-designed structural patterns or molding methods of the thermoplastic adhesive are disclosed in many examples, e.g. U.S. Pat. No. 5,935,670, U.S. Pat. No. 6,139,442, U.S. Pat. No. 6,686,016 and CN1760299A. However, it is found from these molding methods that the glue is dripped onto the surface of a carrier (sheet or strip) by means of intermittent dripping, and then the adhesive unit for the peelable carrier is formed through drying and hardening. However, the following shortcomings are observed during actual application:

1. Excessive thickness of glue: as the glue is dripped onto the surface of a carrier by means of dripping, the arched surface has a bigger thickness that makes it difficult for thinning even through compression, thus increasing the material cost.

2. Slow fabrication speed: the dripping occurs from the dead weight of the glue, so the forming process is very slow. And, the feed speed of carrier also has to match the dripping speed, leading to slower fabrication speed of typical molding method.

3. Poorer adhesion: as an arched surface is shaped from the dripping, the efficient adhesion area and strength is reduced from uneven adhesive surface. For this reason, some pressure is generally applied to the adhesive surface through a tape-rolling process, enabling the surface to be leveled by the deadweight of the tape. While it is difficult to level the surface due to hardening of the adhesive surface, the tight adhesion between the finished adhesive and tape also makes it difficult to peel off the adhesive, or causes the damage of the adhesive.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the innovative design of the hot-melt extruded adhesive tape of the present invention, since the extrusion belongs to an active processing method without waiting for the time interval arising from the dripping, the conveying speed of the carrier can be adjusted, enabling the thermoplastic rubber to be incorporated more quickly and efficiently onto the carrier's peelable surface. This can improve greatly the fabrication efficiency and reduce the cost with better applicability and industrial benefits.

Based on the innovative design of the hot-melt extruded adhesive tape of the present invention, since the extrusion port of the extrusion feed mechanism is designed into a flat pattern, the extruded adhesive can be molded directly into a plain pattern without subsequent compression. So, the extruded adhesive on the carrier's peelable surface can become extremely thin, thus saving the material cost with better applicability and industrial benefits.

Based on the innovative design of the hot-melt extruded adhesive tape of the present invention, since the flat and thin-profile adhesive can be fabricated quickly due to the flat design of the extrusion port, the optimum adhesion strength and effect can be realized. So, the present invention presents an improved strength and applicability as compared to typical dripping method.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the hot-melt extruded adhesive tape of present invention.

FIG. 2 shows a partially sectional view of the preferred embodiment of the hot-melt extruded adhesive tape of present invention.

FIG. 3 shows a plan view of the extruded adhesive of the present invention in a continuously-extended pattern.

FIG. 4 shows a perspective view of the preferred embodiment of present invention wherein the carrier's peelable surface is covered by the peelable film.

FIG. 5 shows a plan abridged view of the preferred embodiment of the molding equipment of the present invention.

FIG. 6 shows a perspective view of the extrusion feed mechanism of the present invention in an actuating state.

FIG. 7 shows a schematic view of a preferred embodiment of the present invention wherein the extrusion feed mechanism is provided with multiple extrusion ports.

FIG. 8 shows a schematic view of a preferred embodiment of the cutting mechanism and the cutting patterns of the present invention.

FIG. 9 shows another schematic view of a preferred embodiment of the cutting mechanism and the cutting patterns of the present invention.

### DETAILED DESCRIPTION OF THE INVENTION

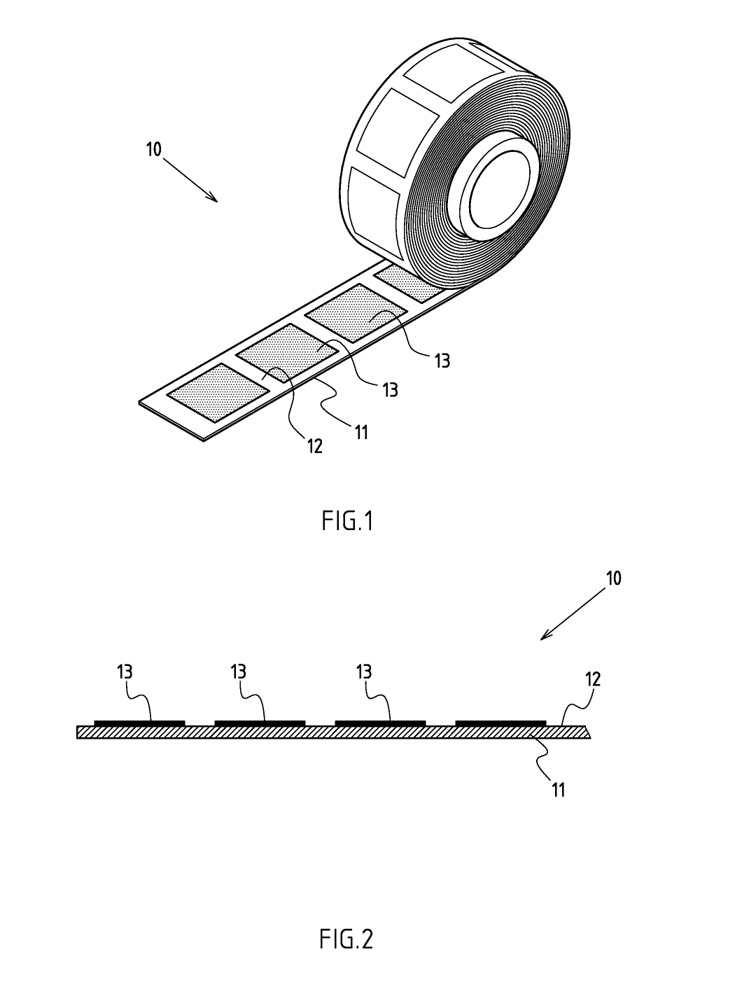

FIGS. 1-3 depict preferred embodiments of hot-melt extruded adhesive tape of the present invention, which, however, are provided for only explanatory objective for patent claims.

The hot-melt extruded adhesive tape 10 comprising a banded, rolled or foliated carrier 11, at one side of which there is a peelable surface 12. The carrier 11 is made of such materials including but not limited to: polyester, polyethylene, PVC, vinyl resin, polystyrene and polypropylene. The carrier 11 disclosed in FIG. 1 is a continuously-extended rolled tape.

At least an extruded adhesive 13 is made of thermoplastic rubber. The extruded adhesive 13 is extruded onto the peelable surface 12 of the carrier 11, or leveled with a thin-profile surface during molding.

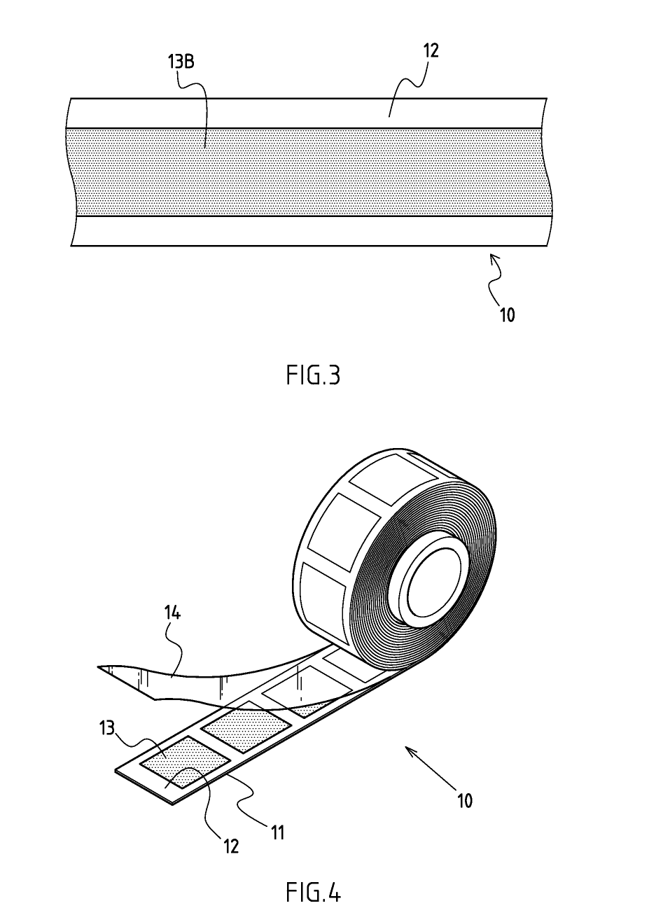

Referring to FIGS. 1 and 2, the extruded adhesives 13 are arranged at interval. Or, referring to FIG. 3, the extruded adhesive 13B is designed into a continuously-extended pattern.

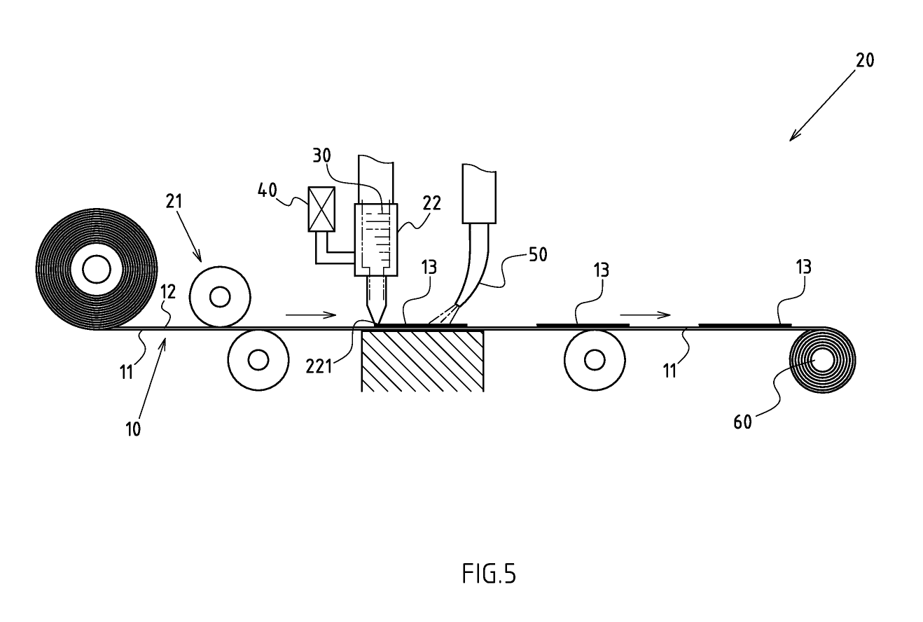

Referring to FIG. 4, the peelable surface 12 of the carrier 11 is covered by a peelable film 14, which is used for covering the extruded adhesives 13. The peeling-off capability of the peelable film 14 is stronger than that of the peelable surface 12 of the carrier 11.

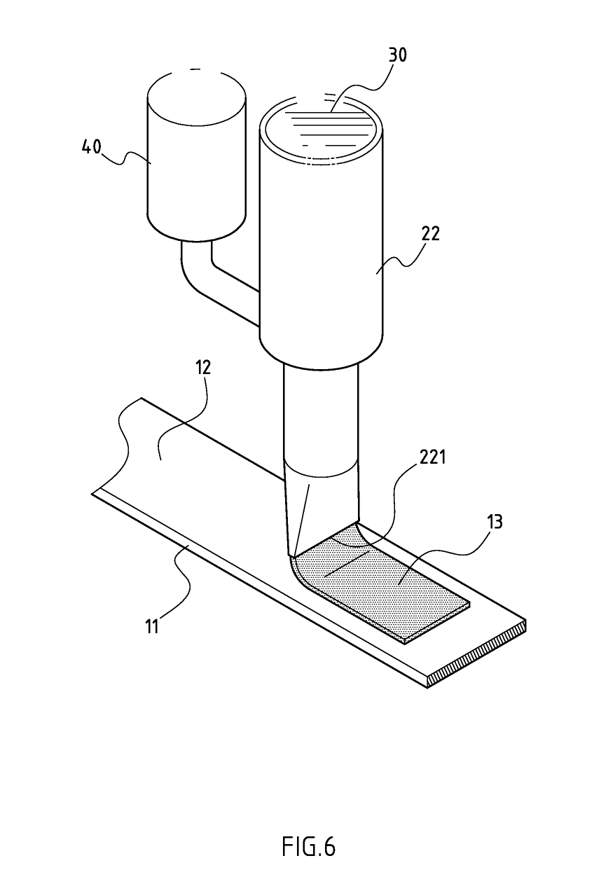

Referring also to FIG. 5, the molding equipment 20 of the hot-melt extruded adhesive tape 10 comprises: a conveying mechanism 21, used to convey the foliated or banded carrier 11 with a peelable surface 12 along a processing path. An extrusion feed mechanism 22, arranged correspondingly to the conveying mechanism 21. The extrusion feed mechanism 22 is provided with an extrusion port 221 correspondingly to the peelable surface 12 of the carrier 11, which is used to extrude the thermoplastic rubber 30 stored in the extrusion feed mechanism 22 to the peelable surface 12 of the carrier 11, so that at least a thin-profile and flat extruded adhesive 13 is formed on the peelable surface 12. Of which, the extrusion port 221 can be designed into a flat pattern of predefined width (as shown in FIG. 6), permitting to extrude into flat and expanded glue very quickly. An intermittent controller 40 is placed correspondingly to the extrusion feed mechanism 22, allowing for intermittent feed of the extruded thermoplastic rubber 30. The intermittent controller 40 is a vacuum suction device linked to the inner end of the extrusion port 221 of the extrusion feed mechanism 22. When the intermittent controller 40 is activated, a vacuum suction force is generated to yield a reverse suction force for the thermoplastic rubber 30 in the extrusion port 221, thus serving the purpose of intermittent feed control. A hardening mechanism 50 is arranged behind the extrusion feed mechanism 22, and used to speed up the hardening of extruded adhesives 13 on the peelable surface 12 into solid adhesive.

With this molding equipment 20, the hot-melt extruded adhesive tape 10 can be molded by the following steps:

(1) Prepare a foliated or banded carrier 11 with a peelable surface 12;

(2) Convey it by a conveying mechanism 21, so as to feed the carrier 11 through an extrusion feed mechanism 22;

(3) Extrude the thermoplastic rubber 30 onto the peelable surface 12 of the carrier 11 from at least a 0.2 mm˜1.0 mm extrusion port 221 of an extrusion feed mechanism 22, so that at least a thin-profile and flat extruded adhesive 13 is formed on the peelable surface 12;

(4) Conduct intermittent feed control by an intermittent controller 40, so that the thermoplastic rubber 30 is extruded onto the peelable surface 12 of the carrier 11 to form extruded adhesive 13 at interval; if intermittent feed control is not used, the thermoplastic rubber 30 is extruded continuously to form continuously-extended extruded adhesive 13B (as shown in FIG. 3); moreover, with the intermittent extrusion in tune with the flat cross section of the extrusion port 221, the intermittent feed control enables the extruded thermoplastic rubber 30 to be cut off automatically with the shift of the carrier 11;

(5) Perform a hardening process by a hardening mechanism 50, allowing the extruded adhesive 13 to be hardened quickly into solid adhesive.

Referring to FIG. 5, a rolling mechanism 60 is placed behind the hardening mechanism 50, so the banded carrier 11 with extruded adhesive 13 is guided into rolled shape.

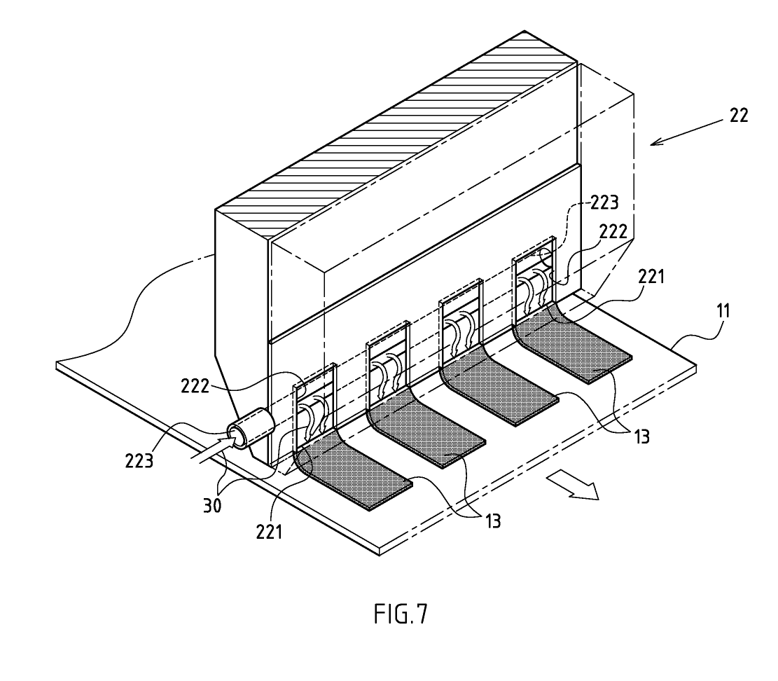

Referring to FIG. 7, the extrusion feed mechanism 22 is provided with multiple extrusion ports 221. In this preferred embodiment, flat guide channels 222 are arranged at interval within the extrusion feed mechanism 22 correspondingly to the extrusion ports 221, and also linked to a feed channel 223 of the thermoplastic rubber 30. Some extruded adhesive 13 could be extruded at interval from a carrier 11 in this preferred embodiment.

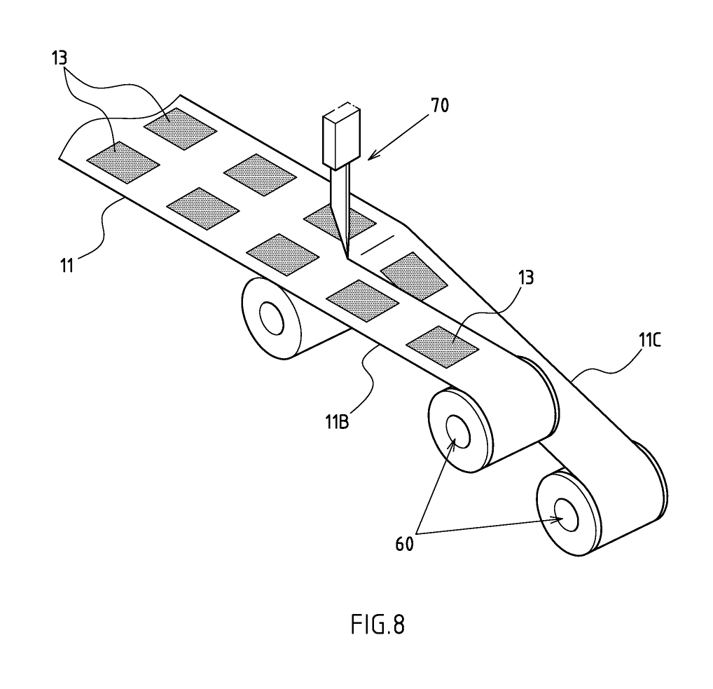

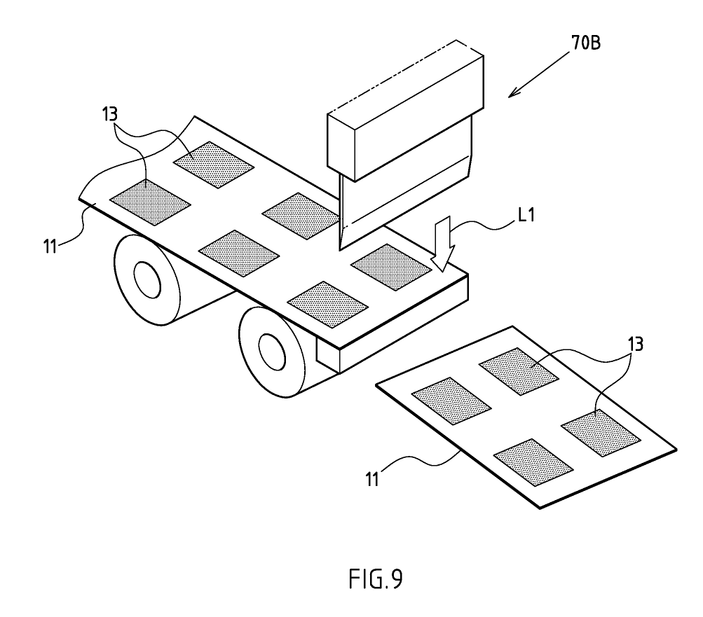

Referring to FIG. 8, a cutting mechanism 70 is placed behind the hardening mechanism 50, so the carrier 11 with the extruded adhesive 13 is cut into a plurality of carriers 11B, 11C. The cutting patterns vary from the design of the cutting mechanism 70. The cutting mechanism 70 shown in FIG. 8 allows to cut the carrier 11 into two banded carriers 11B, 11C by means of central cutting, or the cutting mechanism 70B shown in FIG. 9 allows to cut the carrier 11 into foliated shapes (indicated by arrow L1).

1. A method for molding hot-melt extruded adhesive tape comprising the steps of:
prepare a foliated or banded carrier with a peelable surface;
convey it by a conveying mechanism so as to feed the carrier through a feed mechanism;
extrude the thermoplastic rubber onto the peelable surface of the carrier from at least a 0.2 mm˜1.0 mm extrusion port, so that at least a thin-profile and flat extruded adhesive is formed on the peelable surface;
conduct intermittent feed control so that the thermoplastic rubber is extruded onto the peelable surface of the carrier and arranged at interval; if intermittent feed control is not used, the thermoplastic rubber is extruded continuously; moreover, with the intermittent extrusion in tune with the flat cross section of the extrusion port, the intermittent feed control enables the extruded thermoplastic rubber to be cut off automatically with the shift of the carrier;
perform a hardening process by a hardening mechanism, allowing the extruded adhesive to be hardened quickly into solid adhesive, thus forming a hot-melt extruded adhesive tape.

2. The method defined in claim 1, wherein a rolling mechanism is placed behind the hardening mechanism, so the banded carrier with extruded adhesive is guided into rolled shape.

3. The method defined in claim 2, wherein a cutting mechanism is placed behind the hardening mechanism, so the carrier with extruded adhesive is cut into a plurality of foliated or banded carriers.

4. The method defined in claim 1, wherein the molding method is realized by a molding equipment, which comprising:
a conveying mechanism, used to convey the foliated or banded carrier with a peelable surface along a processing path;
an extrusion feed mechanism, arranged correspondingly to the conveying mechanism;
the extrusion feed mechanism is provided with an extrusion port correspondingly to the peelable surface of the carrier, which is used to extrude the thermoplastic rubber stored in the extrusion feed mechanism to the peelable surface of the carrier, so that at least a thin-profile and flat extruded adhesive is formed on the peelable surface; of which, the height of the extrusion port is 0.2 mm˜1.0 mm;
an intermittent controller, placed correspondingly to the extrusion feed mechanism, allowing for intermittent feed of the extruded thermoplastic rubber;
a hardening mechanism, arranged behind the extrusion feed mechanism, and used to speed up the hardening of extruded adhesives on the peelable surface into solid adhesive.

5. The method defined in claim 4, wherein a rolling mechanism is placed behind the hardening mechanism, so the banded carrier with extruded adhesive is guided into rolled shape.

6. The method defined in claim 4, wherein a cutting mechanism is placed behind the hardening mechanism, so the carrier with the extruded adhesive is cut into a plurality of carriers.

7. The method defined in claim 4, wherein the intermittent controller is a vacuum suction device linked to the inner end of the extrusion port of the extrusion feed mechanism; when the intermittent controller is activated, a vacuum suction force is generated to yield a reverse suction force for the thermoplastic rubber in the extrusion port, thus serving the purpose of intermittent feed control.

8. The method defined in claim 1, wherein a the hot-melt extruded adhesive tape comprises: a banded or foliated carrier, at one side of which there is a peelable surface;
at least an extruded adhesive, made of thermoplastic rubber; the extruded adhesive is extruded onto the peelable surface of the carrier, or leveled with a thin-profile surface during molding.

9. The method defined in claim 1, wherein the carrier is also formed into a continuously-extended rolled pattern.

10. The method defined in claim 1, wherein the peelable surface of the carrier is covered by a peelable film, which is used for covering the extruded adhesives; the peeling-off capability of the peelable film is stronger than that of the peelable surface of the carrier.

11. The method defined in claim 1, wherein the extruded adhesive is formed into a continuously-extended pattern.

12. The method defined in claim 1, wherein the extruded adhesive is arranged at interval.
